(19) United States
(12) Patent Application Publication
(10) Pub. No.: US 2026/0140750 A1
(43) Pub. Date: May 21, 2026

(54) MULTI-AGENT ARTIFICIAL INTELLIGENCE MODEL FRAMEWORK FOR USER INTERFACE NAVIGATION

(71) Applicant: PAYPAL, INC., San Jose, CA (US)

(72) Inventors: Angadhjot Hundal, Albany, CA (US); Wenhuan Sun, San Jose, CA (US); Ishmael Umar Ali Dizon Maniku, Dublin, CA (US)

(21) Appl. No.: 18/951,299

(22) Filed: Nov. 18, 2024

(51) Int. Cl. G06F 9/451; G06F 3/0483; G06F 3/0484; G06F 16/954

(52) U.S. Cl. CPC G06F 9/453; G06F 3/0483; G06F 3/0484; G06F 16/954

(57) ABSTRACT

Methods and systems are presented for providing an artificial intelligence (AI) framework for navigating through electronic user interfaces (UIs). The AI framework includes a navigation module that communicates with various components of a computer system for accessing an interacting different UI pages. After accessing a first UI page, the navigation module analyzes an image of the first UI page, and generates a prompt for an AI model. The prompt instructs the AI model to generate a set of navigation instructions for interacting with the first UI page that enables the navigation module to navigate to a predetermined target UI page. The navigation module interacts with the first UI page according to the set of navigation instructions. The interactions trigger an access of a second UI page. The navigation module iteratively uses the AI model to continue to navigate through various UI pages until the target UI page is accessed.

### BACKGROUND

The present specification generally relates to an artificial intelligence model framework, and more specifically, to providing an artificial intelligence model framework for automated navigations of electronic user interfaces according to various embodiments of the disclosure.

### Related Art

Automated computer tools for navigating electronic user interfaces (UIs), such as web crawlers, have been used for collecting and analyzing information (e.g., webpages, etc.) on a network. However, conventional navigation tools are typically static, in that they include a fixed set of rules for navigating from one UI page to another UI page. For example, a conventional navigation tool may identify links (e.g., one or more UI elements that are associated with network addresses corresponding to other UI pages) within a user interface, and may access the other UI pages based on the links. Due to the increasingly sophisticated designs of user interfaces, such a static approach may not always enable the navigation tool to reach all of the available UI pages. Furthermore, conventional navigation tools may not be optimal in navigating through electronic user interfaces when the goal is to reach a specific target UI page (instead of reaching any available UI pages), which can result in more navigation than needed, thereby increasing usage of computing resources. Thus, there is a need for an improved framework for performing automated electronic user interface navigations.

### BRIEF DESCRIPTION OF THE FIGURES

FIG. 1 is a block diagram illustrating an electronic transaction system according to an embodiment of the present disclosure;

FIG. 2 is a block diagram illustrating a UI analysis module according to an embodiment of the present disclosure;

FIG. 3 illustrates an example user interface page according to an embodiment of the present disclosure;

FIG. 4 illustrates another example user interface page according to an embodiment of the present disclosure;

FIG. 5 illustrates an example target user interface page according to an embodiment of the present disclosure;

FIG. 6 illustrates an example modification of a user interface page according to an embodiment of the present disclosure;

FIG. 7 is a flowchart showing a process of navigating user interfaces according to an embodiment of the present disclosure;

FIG. 8 illustrates an example neural network that can be used to implement a machine learning model according to an embodiment of the present disclosure; and

FIG. 9 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for providing an artificial intelligence (AI) model framework for navigating through electronic user interfaces (UIs). In some embodiments, the AI model framework provides efficient navigation from a starting electronic UI page with a goal to reach a target electronic UI page through interacting with one or more UI pages. Electronic UI pages are user interfaces that can be dynamically rendered on any electronic display, such as a display of a computer device, a display of a mobile device (e.g., a smart phone, a wearable device, etc.), or a display of an appliance (e.g., a television, a refrigerator, etc.). These UI pages are dynamic because they can be programmed (e.g., using programming code such as HTML, JavaScript, JAVA, etc.) to display any UI element (e.g., text, images, video clips, symbols, buttons, etc.) in any arrangement. An electronic UI page can also be interactive, as some of the UI elements within the UI page can be programmed to enable interactions with an operator (e.g., a user or a computer module). For example, a UI element (e.g., a text, an image, a symbol, etc.) can be programmed such that an interaction (e.g., selecting the UI element, hovering a cursor over the UI element, etc.) with the UI element can cause an action associated with the UI page. The action may include a change of a presentation (or a rendering of the presentation) of the UI page (e.g., changing a UI element, such as text, images, etc. displayed on the UI page, etc.), a generation and rendering of an additional UI (e.g., a pop-up window, etc.), and/or a redirection to another UI page (e.g., a link that directs the user to another webpage, etc.).

In some instances, multiple UI pages may be associated with each other (e.g., associated with the same application, such as a website hosted by an entity, a mobile application, etc.). For example, a website hosted by an entity may include multiple UI pages (e.g., multiple webpages associated with the same website). In another example, an application (e.g., a mobile application, a desktop application, etc.) may also include multiple UI pages (e.g., screens or pages of the same application, etc.). The UI pages that are associated with the same application may be linked with each other such that an operator (e.g., a user or a computer module, etc.) may navigate through different UI pages within the application by interacting with them (e.g., selecting different UI elements within each UI page, etc.). In this regard, the application may be designed and programmed such that certain transactions (e.g., conducting a purchase of an item offered by the application, accessing a particular type of data, editing a setting of a user account, etc.) can be conducted through different flows among the UI pages (e.g., navigating through different sequences of UI pages associated with the application, etc.). For example, navigating from a homepage of a merchant website to a product webpage, and then to a checkout webpage of the website may enable an operator to conduct a purchase transaction of a product with the merchant. In another example, navigating from a home screen of a mobile application to a login page of the application, and then to an account summary page of the application may enable an operator to access account data of a user account with an entity associated with the application.

It is often desirable to utilize automated navigation tools to collect and analyze information of a specific type of UI. For example, an organization may desire to collect information and analyze UIs corresponding to a particular type (e.g., checkout pages, account summary pages, etc.) from different applications. As used herein, the UIs that correspond to a particular type, and which information is to be extracted and analyzed, are referred to as “target UIs” or “target UI pages”. These target UI pages may not be accessible directly (e.g., by entering a network address such as a URL on a web browser, etc.). Instead, these target UI pages most often can only be accessed through navigating from other UI pages of an application (e.g., a homepage of a website, etc.). Navigating through these UI pages to reach the target UI pages may seem trivial when performed by a human. However, it can be a challenge for a computer tool to navigate through one or more UI pages to reach the target UI page. For example, in order to reach a checkout page of a merchant website from a homepage of the merchant website, the computer tool may have to first navigate to a product page of a product within the merchant website. Once the product page is accessed, the computer tool may also have to perform additional interactions with the product page before being able to navigate to the checkout page. For example, the product page may require a selection of a product configuration, may require inputting credentials associated with a user account, may require a selection of proceeding as a registered user or a guest user, may require solving a puzzle, and/or other interactions before a link to the checkout page is activated (e.g., the link to the checkout page may be invisible or disabled until the required interaction(s) are performed, etc.).

These interactions can be challenging for a computer system to perform. For example, as discussed herein, while conventional navigation tools may be capable of navigating through various UI pages on a network (e.g., accessing various UI pages associated with an application, etc.), due to its static nature, these navigation tools may not be successful in navigating to the target UI page (e.g., a checkout page, an account summary page, etc.) in an efficient manner, or may not even be able to navigate to the target UI page at all. This is because conventional navigation tools rely on static rules and programming logics to access different UI pages (e.g., identifying links in a UI page and accesses the other UI pages based on the links, etc.), and may not be capable of reaching the target UI pages in the most direct path. Worse yet, the conventional navigation tools may not have sufficient computational capability and/or programming logic to accommodate the different interactions (e.g., solving a challenge, registering a user account, closing a pop-up window, etc.) required by different applications in order to reach the target UI pages.

As such, according to various embodiments of the disclosure, an AI model framework is provided for navigating through electronic UIs with a goal to reach one or more target UI pages in an efficient manner, such as with the least number of navigations through interim UI pages. In some embodiments, the AI model framework may include multiple computer modules that work together with an AI model to facilitate the navigation of UI pages to reach the one or more target UI pages. For example, the AI model framework may include a navigation module configured to coordinate the navigation of different UI pages by interacting with a UI application (e.g., a web browser, a mobile application, etc.) and an operating system of a computer system (e.g., a computer device, a computer server, etc.). The AI model framework may also include an AI model configured to generate navigation instructions for navigating toward a target UI page.

In some embodiments, the navigation module obtains the navigation instructions from the AI model, and instructs the operating system and/or the UI application of the computer system to interact with a UI page presented on the computer system. For example, the navigation module may initially access a first UI page of an application (e.g., a homepage of a website, a home screen of a mobile application, etc.). The navigation module may instruct the UI application to render the first UI page on a display of the computer system. When the UI application is a web browser, the navigation module may instruct the web browser to transmit a HyperText Transfer Protocol (HTTP) request to the Internet based on a network address (e.g., a URL) of a website. The web browser may receive, as a response to the HTTP request, content of a webpage, which likely corresponds to a homepage of the website. The content may include programming code that can be executed/interpreted by the web browser for rendering on a display of a computer system. When the UI application is a non-browser application, the navigation module may instruct the operating system (via one or more application programming interface (API) calls, etc.) to launch and/or execute the application. The application may present, on the display of the computer system, a home screen associated with the application.

The navigation module may then derive information associated with the first UI page, and may provide the information to the AI model. The information may include an image (e.g., a screenshot) of the first UI page. For example, the navigation module may instruct the operating system of the device to capture a screenshot of the rendering of the first UI page (e.g., via one or more API calls, etc.) on the device. The navigation module may also analyze the first UI page and derive additional data from the first UI page. For example, the navigation module may analyze the UI elements that are displayed on the first UI page and/or the programming code used by the UI application to render the first UI page. The navigation module may label different areas of the image based on the characteristics of the elements (e.g., user interface elements) rendered on the first UI page and portions of the programming code corresponding to the elements. The navigation module may label an area within the image that corresponds to a link to a first product on the first UI page, may label another area within the image that corresponds to a link to a second product on the first UI page, may label another area within the image that corresponds to a shopping cart link on the first UI page, etc.

The navigation module may then generate a prompt for the AI model. The prompt may include specific instructions for the AI model to provide a set of navigation instructions for navigating to the target UI page (e.g., the checkout page, the account summary page, etc.). The prompt may also include the image of the first UI page, the labeled elements (e.g., labeled user interface elements, etc.), and/or the programming code associated with the first UI page. In some embodiments, the prompt also includes information related to a particular format of the output. Based on the prompt, the AI model may be trained to generate a set of navigation instructions for navigating from the first UI page (e.g., interacting with the first UI page, etc.) with a goal to reach the target UI page in the most direct manner.

The set of navigation instructions may indicate one or more interactions with the first UI page and a reason for the one or more user interactions. For example, the set of navigation instructions may indicate a selection of one or more of the UI elements (e.g., a link, a button, an image, etc.) on the first UI page. In some embodiments, the set of navigation instructions may specify the one or more UI elements to be selected based on a location (e.g., a set of coordinates, etc.) of each of the one or more UI elements on the image. When the set of navigation instructions indicates selections of multiple UI elements, the set of navigation instructions may also specify a sequence (e.g., an order) of the selections of the multiple UI elements (e.g., select a drop-down menu locating on the top right corner of the image, then select the product catalogue button in the drop-down menu, etc.).

An example output from the AI model may include a “thought” portion, such as “I see a ‘Shop Now’ button which likely leads to product listings” and an instruction portion, such as “click on the ‘Shop Now’ button at the coordinate {x:0.75, y:0.55}.” In this example, the AI model was instructed to navigate to a checkout page of the website. The AI output indicates that selecting the “Shop Now” button on the first UI page would likely lead to the target UI page (e.g., the checkout page). The AI output also provides a set of coordinates corresponding to a location of the display of the device on which the first UI page is rendered.

In some embodiments, due to the sophisticated design of a UI page, the AI model may output a set of navigation instructions that includes a sequence of interactions. For example, if the first UI page prompts the operator to choose to sign in to an account with the application or proceed as a “guest user” in a pop-up window, the AI model may specify a selection of the “guest user” and an interaction with a button for closing the pop-up window. In another example, if the UI page requires solving a challenge before allowing the UI application to access a subsequent UI page, the AI model may output a set of navigation instructions that includes a sequence of interactions for solving the challenge (e.g., if the UI page prompts the operator to select images, from a set of images, that include a bridge, the AI model may identify images that include a bridge and provide instructions for selecting those images, etc.). The interactions specified by the AI model may enable the UI application to access subsequent UI pages.

The navigation module may then perform the one or more interactions with the first UI page according to the set of navigation instructions. For example, the navigation module may make one or more API calls with the operating system and/or the UI application of the computer system to interact with the first UI page. In some embodiments, the navigation module uses one or more API calls to control the input components (e.g., a keyboard, a mouse, etc.) of the computer system via the operating system. For example, the navigation module may instruct the computer system to select (e.g., click) at a location specified by the set of navigation instructions. By interacting with the first UI page according to the set of navigation instructions, the UI application may update (e.g., modify) the first UI page or may be directed to a different UI page (e.g., a second UI page).

In some embodiments, performing the interactions according to the set of navigation instructions causes the first UI page to be modified based on the programming code associated with the first UI page. For example, in response to a selection of a drop-down menu button, a drop-down menu may appear on the first UI page. In another example, in response to a selection of a “Shop Now” button, a pop-up window may appear, prompting an operator to sign in to an account with the website. In yet another example, a bot detector may be implemented in the application to prevent non-human operators from navigating through the UI pages of the application. Thus, in response to selecting a link to the second UI page, a challenge (such as a puzzle rendered in a pop-up window, etc.) may appear on the first UI page, and will only allow access to the second UI page if the challenge is solved. As such, the navigation module may need additional navigation instructions from the AI model based on the modified first UI page. In some embodiments, performing the interactions according to the set of navigation instructions causes the UI application to be directed to a second UI page.

As such, after a new UI page (e.g., the modified first UI page or the second UI page) is rendered by the UI application in response to the interactions, the navigation module may analyze the new UI page to determine whether the new UI page corresponds to or is the target UI page (e.g., whether the new UI page corresponds to a checkout page, whether the new UI page corresponds to an account summary page, etc.). The navigation module may analyze the elements within the new UI page. For example, the navigation module may detect whether a particular element associated with the target UI page (e.g., payment options on a checkout page, account balance data on an account summary page, etc.) is rendered on the new UI page. The navigation module may also determine whether an arrangement of different UI elements on the new UI page corresponds to the target UI page.

If the navigation module determines that the new UI page does not correspond to the target UI page, the navigation module may again instruct the AI model to provide another set of navigation instructions for navigating from the new UI page with a goal to reach the target UI page. For example, the navigation module may obtain an image of the new UI page. The navigation module may also analyze the elements within the new UI page (e.g., based on the programming code associated with the new UI page), and label the elements on the image of the new UI page. The navigation module may then generate another prompt for the AI model, for instructing the AI model to generate another set of navigation instructions for navigating to the target UI page based on the image of the new UI page, the labeled elements, and/or the programming code.

On the other hand, if the navigation module determines that the new UI page corresponds to the target UI page, the navigation module may use another computer module (e.g., an analytic module) to collect information and/or analyze the new UI page. In some embodiments, the navigation module accesses a set of criteria associated with the target UI page. For example, the set of criteria for a checkout page may include a specific order of payment options displayed on the target UI page. In another example, the set of criteria for an account summary page may include a specific layout of different UI elements. As such, the navigation module may determine whether the new UI page satisfies the set of criteria. For example, when the new UI page corresponds to a checkout page, the navigation module may use the analytic module to analyze the checkout page to determine an order of the payment options displayed on the target UI page (e.g., which payment option is presented first, second, etc. on the target UI page). Such an analysis can be performed using techniques described in U.S. patent application Ser. No. 16/837,840, titled “Systems and Methods for Detecting a Relative Position of a Webpage Element Among Related Webpage Elements,” filed Apr. 1, 2020, issued as U.S. Pat. No. 11,416,244, which is incorporated herein in its entirety. In some embodiments, the analytic module may be another AI model (e.g., another large language model, etc.) that is trained to analyze the elements within the target UI page.

In some embodiments, based on a result from the analysis, the navigation module may perform one or more actions, such as sending a notification to a user device or a computer system based on the result, causing a modification to the target UI page (e.g., change it according to the set of criteria, etc.), and/or any other actions.

Using the AI model framework disclosed herein, a computer system may efficiently and automatically navigate through various UIs to reach a target UI page. The AI model framework improves over conventional navigation tool as it provides dynamic instructions that can accommodate different types of UIs (that includes different UI elements and arrangements, etc.) and that can lead an operator toward one or more target UI pages.

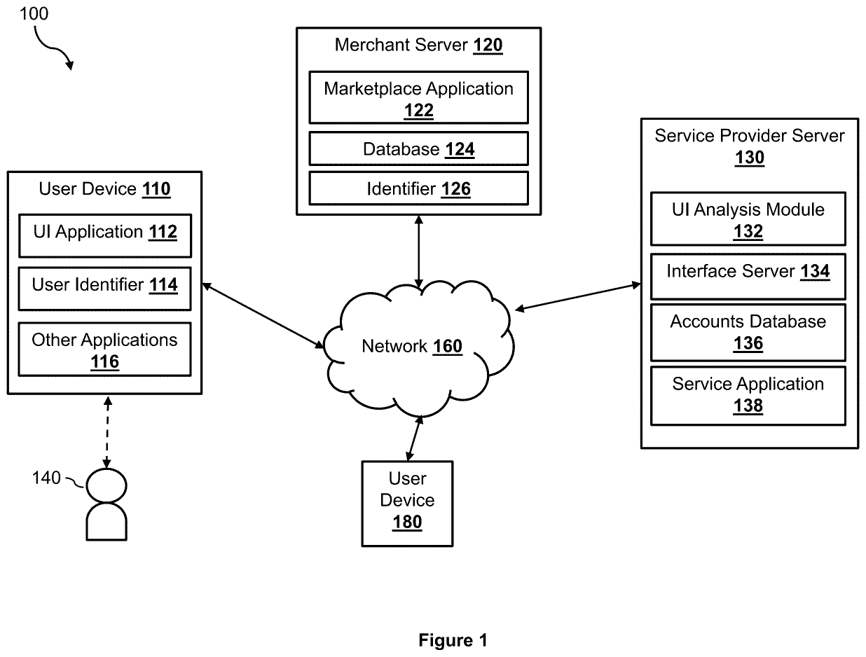

FIG. 1 illustrates an electronic transaction system 100, within which the framework may be implemented according to one or more embodiments of the disclosure. The electronic transaction system 100 includes a service provider server 130, a merchant server 120, and user devices 110 and 180 that may be communicatively coupled with each other via a network 160. The network 160, in one embodiment, is implemented as a single network or a combination of multiple networks. For example, in various embodiments, the network 160 includes the Internet and/or one or more intranets, landline networks, wireless networks, and/or other appropriate types of communication networks. In another example, the network 160 comprises a wireless telecommunications network (e.g., cellular phone network) adapted to communicate with other communication networks, such as the Internet.

The user device 110, in one embodiment, is utilized by a user 140 to interact with the merchant server 120 and/or the service provider server 130 over the network 160. For example, the user 140 uses the user device 110 to conduct an online transaction, such as a purchase, interaction with a merchant or other entity, or data/content access, with the merchant server 120 via websites hosted by, or mobile applications associated with, the merchant server 120. The user 140 also logs in to a user account to access account services or conduct electronic transactions (e.g., data access, account transfers or payments, etc.) with the service provider server 130. The user device 110, in various embodiments, is implemented using any appropriate combination of hardware and/or software configured for wired and/or wireless communication over the network 160. In various implementations, the user device 110 includes at least one of a wireless cellular phone, wearable computing device, PC, laptop, etc.

The user device 110, in one embodiment, includes a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130 and/or the merchant server 120 via the network 160. In another implementation, the user interface application 112 includes a browser module that provides a network interface to browse information available over the network 160. For example, the user interface application 112 may be implemented, in part, as a web browser to view information available over the network 160. Thus, the user 140 may use the user interface application 112 to initiate electronic transactions with the merchant server 120 and/or the service provider server 130.

The user device 110, in various embodiments, includes other applications 116 as may be desired in one or more embodiments of the present disclosure to provide additional features available to the user 140. In one example, such other applications 116 include security applications for implementing client-side security features, programmatic client applications for interfacing with appropriate application programming interfaces (APIs) over the network 160, and/or various other types of generally known programs and/or software applications. In still other examples, the other applications 116 interface with the user interface application 112 and/or the chat client 170 for improved efficiency and convenience.

The user device 110, in one embodiment, includes at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., and a particular profile).

In various implementations, the user 140 is able to input data and information into an input component (e.g., a keyboard or a microphone) of the user device 110. For example, the user 140 may use the input component to interact with the UI application 112 (e.g., to conduct a purchase transaction with the merchant server 120 and/or the service provider server 130, to initiate a chargeback transaction request, etc.).

The user device 180 may include substantially the same hardware and/or software components as the user device 110, which may be used by a user or a computer module to interact with the merchant server 120 and/or the service provider server 130.

The merchant server 120, in various embodiments, may be maintained by a business entity (or in some cases, by a partner of a business entity that processes transactions on behalf of the business entity). Examples of business entities include merchants, resource information providers, utility providers, online retailers, real estate management providers, social networking platforms, a cryptocurrency brokerage platform, etc., which offer various items, content, and/or services for purchase and process payments for the purchases. The merchant server 120 may include a merchant database 124 for identifying available items, content, or services, which may be made available to the user devices 110 and 180 for viewing and purchase by the respective users.

The merchant server 120, in one embodiment, may include a marketplace application 122, which may be configured to provide information over the network 160 to the user interface application 112 of the user device 110. In one embodiment, the marketplace application 122 may include a web server that hosts a merchant website for the merchant. For example, the user 140 of the user device 110 (or a computer module that controls the user device 180 or the service provider server 130) may interact with the marketplace application 122 through the user interface application 112 over the network 160 to search and view various items, content, or services available for purchase in the merchant database 124. The merchant server 120, in one embodiment, includes at least one merchant identifier 126, which may be included as part of the one or more items, content, or services made available for purchase so that, e.g., particular items and/or transactions are associated with the particular merchants. In one implementation, the merchant identifier 126 includes one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

While only one merchant server 120 is shown in FIG. 1, it has been contemplated that multiple merchant servers, each associated with a different merchant, may be connected to the user device 110 and the service provider server 130 via the network 160.

The service provider server 130, in one embodiment, is maintained by a transaction processing entity or an online service provider, which provides processing of electronic transactions between users (e.g., the user 140 and users of other user devices, etc.) and/or between users and one or more merchants. As such, the service provider server 130 includes a service application 138, which may be adapted to interact with the user device 110, user device 180, and/or the merchant server 120 over the network 160 to facilitate the electronic transactions (e.g., electronic payment transactions, data access transactions, interactions, such as chat sessions, etc.) among users and merchants processed by the service provider server 130. In one example, the service provider server 130 is provided by PayPal®, Inc., of San Jose, California, USA, and/or one or more service entities or a respective intermediary that provide multiple point of sale devices at various locations to facilitate transaction routings between merchants and, for example, service entities.

In some embodiments, the service application 138 includes a payment processing application (not shown) for processing purchases and/or payments for electronic transactions between a user and a merchant or between any two entities (e.g., between two users, between two merchants, etc.). In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 also includes an interface server 134 that is configured to serve content (e.g., web content) to users and interact with users. For example, the interface server 134 includes a web server configured to serve web content in response to HTTP requests. In another example, the interface server 134 includes an application server configured to interact with a corresponding application (e.g., a service provider mobile application) installed on the user devices 110 and 180 via one or more protocols (e.g., RESTAPI, SOAP, etc.). As such, the interface server 134 may include pre-generated electronic content ready to be served to users. For example, the interface server 134 stores a log-in page and is configured to serve the log-in page to users for logging into user accounts of the users to access various services provided by the service provider server 130. The interface server 134 may also include other electronic pages associated with the different services (e.g., electronic transaction services, etc.) offered by the service provider server 130. As a result, a user (e.g., the user 140, the user of the user device 180, or a merchant associated with the merchant server 120, etc.) may access a user account associated with the user and access various services offered by the service provider server 130, by generating HTTP requests directed at the service provider server 130.

The service provider server 130, in one embodiment, is configured to maintain one or more user accounts and merchant accounts in an accounts database 136, each of which may be associated with a profile and may include account information associated with one or more individual users (e.g., the user 140 associated with user device 110, the user associated with the user device 180, etc.) and merchants. For example, account information includes private financial information of users and merchants, such as one or more account numbers, passwords, credit card information, banking information, digital wallets used, or other types of financial information, transaction history, Internet Protocol (IP) addresses, device information associated with the user account. In certain embodiments, account information also includes user purchase profile information such as account funding options and payment options associated with the user, payment information, receipts, and other information collected in response to completed funding and/or payment transactions. It is noted that the accounts database 136 (and/or any other database used by the system disclosed herein may be implemented within the service provider server 130 or external to the service provider server 130 (e.g., implemented in a cloud, etc.).

In one implementation, a user has identity attributes stored with the service provider server 130, and the user has credentials to authenticate or verify identity with the service provider server 130. User attributes may include personal information, banking information and/or funding sources. In various aspects, one or more of the user attributes are passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

In various embodiments, the service provider server 130 also includes a user interface (UI) analysis module 132 that implements the AI model framework as discussed herein. In some embodiments, the UI analysis module 132 may automatically navigate through various UIs via the network 160, and collect and analyze particular UI pages (also referred to as “target UI pages”). For example, the UI analysis module 132 may access a target UI page (e.g., a checkout page, etc.) associated with the website hosted by the merchant server 120, and analyze the presentation of the target UI page (e.g., the order of different payment options displayed on the checkout page, etc.). In some embodiments, in order for the UI analysis module 132 to access the target UI page of the website, the UI analysis module 132 may navigate through different UI pages (e.g., different webpages) of the website of the merchant server 120 using the AI model framework as discussed herein.

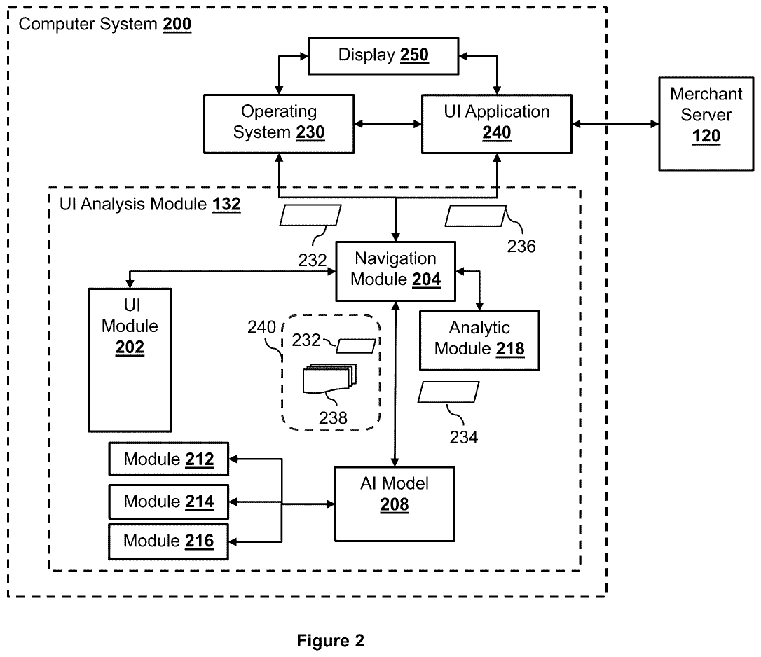

FIG. 2 illustrates a block diagram of the UI analysis module 132 according to an embodiment of the disclosure. As shown, the UI analysis module 132 is implemented within a computer system 200, and may communicate with various components of the computer system 200, such as an operating system 230 of the computer system 200 and/or an UI application 240 of the computer system to perform navigation of UIs. The computer system 200 may correspond to the service provider server 130 or any other devices, such as the user device 110 or the user device 180. The UI application 240 may be similar to the UI application 112 of the user device 110, in that it can be utilized by an operator (e.g., a user or a computer module, such as the UI analysis module 132) to access and interact with various data hosted by servers via the network 160, such as web content hosted by the merchant server 120 or other servers. As such, the UI application 240 may include a software program that can render and display UI pages (e.g., webpages, screens, etc.) associated with different entities (e.g., the merchant associated with the merchant server 120, the service provider associated with the service provider server 130, etc.) on a display 250 of the computer system 200. In one implementation, the UI application 240 is a web browser that provides a network interface to browse information (e.g., webpages) available over the network 160. The webpages may be displayed on the display 250 of the computer system 200. For example, through the UI of the web browser, the UI analysis module 132 may access various webpages of a website hosted by the merchant server 120 (or websites hosted by other servers). The webpages may then be displayed on the display 250. In another implementation, the UI application 240 is a non-browser application that is associated with an entity (e.g., the merchant associated with the merchant server 120). The non-browser application may include a set of pages stored within the computer system to be displayed on the display 250. The non-browser application may also access pages or information stored on a remote device, such as the merchant server 120.

The UI pages accessible by the UI application 240 may be dynamically generated, for example, based on executing and/or interpreting programming code associated with the UI pages by the UI application 240. Furthermore, the UI pages may also be interactive. For example, the UI pages may include interactable UI elements (e.g., a button, a link, text input fields, etc.), such that the UI analysis module 132 may interact with the UI pages via the operating system 230 and/or the UI application 240. Interactions with a UI page may trigger an action, such as a modification to a presentation of the UI page or a redirection to another UI page that is displayed on the display 250. As such, the UI analysis module 132 may navigate through various UI pages (e.g., different webpages of a website, different screens of an application, etc.) by interacting with the UI pages via the operating system 230 and the UI application 240.

As shown in FIG. 2, the UI analysis module 132 includes a UI module 202, a navigation module 204, an artificial intelligence (AI) module 208, an analytic module 218, and a set of computer modules 212, 214, and 216. The UI analysis module 132 may use the UI module 202 to present a UI page on the display 250, which may enable a user to submit a navigation request. For example, a user may, via the user interface provided by the UI module 202, specify a target UI page (e.g., a checkout page, an account summary page, etc.) to access and analyze. The user may also specify one or more applications (e.g., one or more websites, one or more non-browser applications of the computer system 200, etc.) for which navigations will be performed.

Upon receiving the target UI page and an identification of an application, the navigation module 204 may access a first UI page of the application. For example, when the application specified in the navigation request is a non-browser application, the navigation module 204 may instruct the operating system 230, via one or more application programming interface (API) calls, to launch the application (e.g., the UI application 240, where the UI application 240 is a non-browser application). By launching the UI application 240, the UI application 240 may render a first UI page (e.g., a home screen) on the display 250. In another example, when the application specified in the navigation request is a web application (e.g., a website), the navigation module 204 may use a web browser (e.g., the UI application 240) of the computer system 200 to submit a HTTP request based on an address of the website. The UI application 240 may receive a response from a server that hosts the website (e.g., the merchant server 120). The response may include programming code (e.g., HTML code, JavaScript, etc.) that can be executed by the UI application 240 to render a first UI page (e.g., a homepage) of the website on the display 250.

As discussed herein, the target UI page typically cannot be directly accessed through the UI application 240, but may be accessed via interacting with one or more UI pages associated with an application. For example, the target UI page may be accessed from the first UI page by interacting with the first UI page and one or more intermediate UI pages. In some embodiments, the navigation module 204 may use the AI model 208 to determine a set of navigation instructions for navigating from the first UI page to the target UI page. For example, once the UI application 240 has accessed the first UI page and rendered the first UI page on the display 250, the navigation module 204 may analyze the first UI page.

The first UI page may include different elements (e.g., texts, images, interactive elements such as links, buttons, text boxes, checkboxes, etc.) that are arranged to be rendered at different locations on the display 250. Some of the elements may be static, that is, the presentation of these static elements does not change. Some of the elements may be interactive, such that an interaction with the interactive elements may cause the UI application 240 to perform an action that may modify the appearance of the first UI page or may access a different UI page (e.g., a different webpage, a different screen) of the application. By interacting with one or more of the interactive elements of the first UI page, the navigation module 204 may cause the UI application 240 to access the target UI page, or another UI page via which the target UI page can be accessed. It is noted that not all interactions with the first UI page may lead to the target UI page. Using an example where the target UI page corresponds to a “checkout” page of the application, when the first UI page includes a link associated with a “company policy” page of the application, selecting that link will only enable the UI application 240 to access the “company policy” page, and does not bring the UI application 240 any closer to accessing a “checkout” page of the application. On the other hand, when the first UI page includes a link associated with a “product” page that lists a set of products offered for sale on the application, selecting that link will enable the UI application 240 to access the “checkout” page of the application, or to access one or more other UI page, via which the UI application 240 may access the “checkout” page.

As such, the navigation module 204 needs to interact with the first UI page in a manner that will lead to the target UI page efficiently. Instead of accessing all of the available links included in the first UI page, the navigation module 204 may use the AI model 208 to determine a set of navigation instructions for interacting with the first UI page and navigating away from the first UI page. In some embodiments, the navigation module 204 obtains an image 232 of the first UI page that is rendered on the display 250. For example, the navigation module 204 may, via one or more API calls, instruct the operating system 230 to capture a screenshot of the display 250 (e.g., an image that represents the elements presented on the display 250). The navigation module 204 may also analyze elements that are rendered on the first UI page. For example, the navigation module 204 may identify different elements of the first UI page on the image 232, and derive attributes for the different elements based on the programming code of the first UI page. The attributes of an element may include an element type (e.g., whether the element is static or interactive, whether the element includes a link to another UI page or causes an action on the first UI page, etc.), a description of the element which can be derived from metadata associated with the element and included in the programming code (e.g., a title associated with the element, a comment that describes the element, etc.), a content of the element (e.g., texts that are displayed on the display 250, etc.), an address and a description of a link if the element includes a link, and other information associated with the element. The navigation module 204 may label the different elements appearing on the image 232 with the corresponding attributes. The labeled elements may assist the AI model 208 in generating the navigation instructions for the first UI page.

The navigation module 204 may then generate a prompt 240 for the AI model 208, the prompt 240 instructing the AI model 208 to provide a set of navigation instructions for navigating to the target UI page. The prompt 240 may be generated to include the image 232 of the first UI page of the application, the labeled elements 238 on the image 232, and the programming code associated with the first UI page. The navigation module 204 may also include, in the prompt 240, specific instructions for instructing the AI model to provide navigation instructions to a specific target UI page (e.g., a “checkout” page, an “account summary” page, etc.), and a format of the output (e.g., a format of the navigation instructions, etc.).

Based on the prompt 240, the AI model 208 may be trained to generate a set of navigation instructions 234. The set of navigation instructions 234 may specify one or more interactions with the first UI page. The one or more interactions may include a selection of a particular link/button on the first UI page, providing texts to a text box on the first UI page, hovering a cursor over a particular button, etc. In some embodiments, the set of navigation instructions 234 may also provide a reasoning for why the specified interaction(s) may lead to the target UI page, one or more specific locations for the interaction(s), and one or more actions to be performed at the specific locations.

In an example where the AI model 208 is instructed to navigate to a “checkout” page of an application, the AI model 208 may generate an output, such as: “{‘thought’: ‘I see a ‘Shop Now’ button which likely leads to product listings’, ‘operation’: ‘click’, ‘location’: ‘x:085, y:0.75’}.” In this example, the output indicates that selecting (e.g., clicking, etc.) the “Shop Now” button on the first UI page would likely enable the UI application 240 to access a “checkout” page of the application. The output also provides a set of coordinates corresponding to a location of the image 232 for performing the specified action (e.g., the location of the “Shop Now” button).

In some embodiments, due to the sophisticated design of a UI page, more than one interaction with the UI page may be required before a subsequent UI page can be accessed. For example, certain applications require a user to either sign in to a user account with the application or proceed as a “guest user” before allowing the user to continue browsing the website or the application. Such a prompt for signing in may be presented in an overlay and/or a pop-up window. In another example, a UI page may require solving a challenge (e.g., a puzzle) as part of a human verification process. Examples of such a challenge include a selectable box for confirming that the operator is a human, a puzzle including multiple images that requires the operator to select images with a specific attribute (e.g., images that include a bridge, etc.).

In some embodiments, the AI model 208 may use one or more computer modules, such as modules 212, 214, and 216, for assistance in navigating through these complicated UI designs. For example, each one of the modules 212, 214, and 216 may be specialized in navigating through a corresponding type of UI design. The module 212 may be specialized in navigating through UIs that include challenges, the module 214 may be specialized in navigating through UIs that include sign-in requests, and the module 216 may be specialized in navigating through UIs that are presented in pop-up windows, etc. Once the AI model 208 identifies a specific type of UI design (e.g., a challenge, a sign-in request, etc.), the AI model 208 may request a corresponding module to provide instructions in navigating through the UI pages.

The AI model 208 may then provide, to the navigation module 204, the set of instructions 234 as a response to the prompt 232. The navigation module 204 may then cause a set of interactions to be performed on the first UI page of the application displayed on the display 250 according to the set of navigation instructions 234. For example, the navigation module 204 may instruct the operating system 230, via one or more API calls 236, to perform one or more interactions at one or more locations on the display 250 (e.g., clicking at the location having the coordinates {0.85, 0.75}, etc.). In another example, the navigation module 204 may instruct the UI application 240 to perform the one or more interactions on the first UI page directly according to the set of navigation instructions 234.

The one or more interactions performed on the first UI page may trigger an action. For example, the one or more interactions may cause a modification to a presentation of the first UI page (e.g., a presentation of a drop-down menu, a presentation of a pop-up window, etc.), or may cause the UI application 240 to access and render a different UI page (a second UI page). As such, the UI application 240 may render the new UI page (e.g., the modified first u UI page, the second UI page, etc.) on the display 250.

After the new UI page is rendered by the UI application 240 on the display 250, the navigation module 204 may analyze (or use the AI model 208 to analyze) the new UI page to determine whether the new UI page corresponds to or is the target UI page (e.g., whether the new UI page corresponds to a checkout page, whether the new UI page corresponds to an account summary page, etc.). The navigation module 204 may analyze the elements within the new UI page. For example, the navigation module 204 may detect whether a particular element associated with the target UI page (e.g., payment options on a checkout page, account balance data on an account summary page, etc.) is rendered on the new UI page. The navigation module 204 may also determine whether an arrangement of different UI elements on the new UI page corresponds to the target UI page.

If the navigation module 204 determines that the new UI page does not correspond to or is not the target UI page, the navigation module may again instruct the AI model 208 to provide another set of navigation instructions for navigating from the new UI page with a goal to reach the target UI page. For example, the navigation module 204 may obtain an image of the new UI page. The navigation module 204 may also analyze the elements within the new UI page e (e.g., based on the programming code associated with the new UI page), and label the elements on the image of the new UI page. The navigation module 204 may then generate another prompt for the AI model 208, for instructing the AI model 208 to generate another set of navigation instructions for navigating to the target UI page based on the image of the new UI page, the labeled elements, and/or the programming code.

On the other hand, if the navigation module 204 determines that the new UI page corresponds to or is the target UI page, the navigation module 204 may use another computer module (e.g., an analytic module 218) to collect information and/or analyze the new UI page. For example, when the new UI page corresponds to a checkout page, the navigation module 204 may use the analytic module 218 to analyze the checkout page to determine an order of the payment options displayed on the target user interface (e.g., which payment option is presented first, second, etc. on the target UI page). Such an analysis can be performed using techniques described in earlier referenced U.S. patent application Ser. No. 16/837,840, titled “Systems and Methods for Detecting a Relative Position of a Webpage Element Among Related Webpage Elements,” filed Apr. 1, 2020, issued as U.S. Pat. No. 11,416,244. In some embodiments, the analytic module 218 may be another AI model (e.g., another large language model, etc.) that is trained to analyze the elements within the target UI page.

In some embodiments, based on a result from the analysis, the navigation module 204 may perform one or more actions, such as sending a notification to a device (e.g., the user device 110, the merchant server 120, etc.) based on the result, causing a modification to the target UI page (e.g., modifying the programming code of the target UI page, etc.), or any other actions.

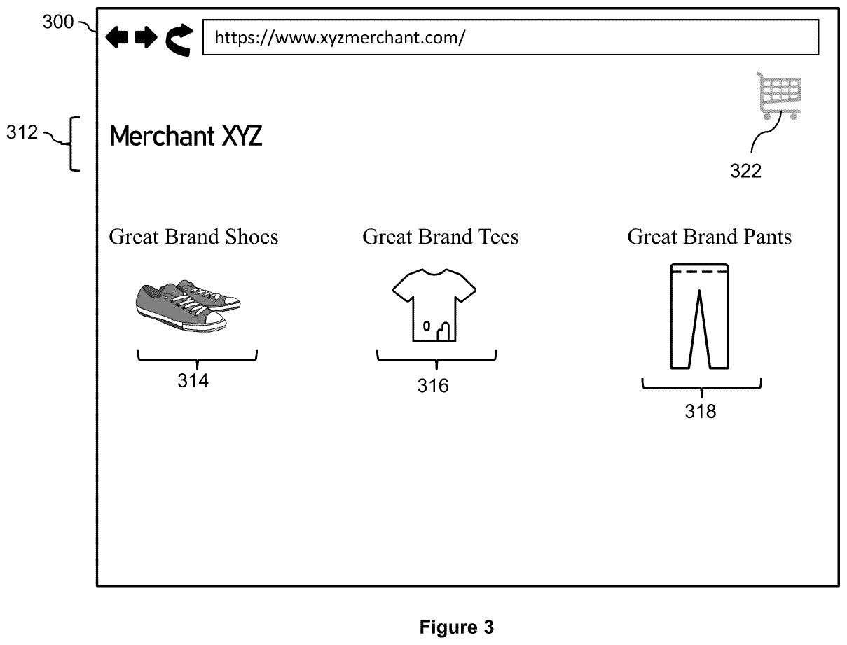

FIG. 3 illustrates an example rendering of a UI page 300 of an application according to some embodiments of the disclosure. In this example, the UI page 300 is rendered by a web browser, which may correspond to the UI application 240. The web browser may transmit an HTTP request to the Internet based on an address, such as “https://www.xyzmerchant.com/”, and may receive programming code associated with the UI page 300 from a host server, which may be a homepage of a website associated with a merchant. The web browser may render the UI page 300 by executing and/or interpreting the programming code.

As shown in FIG. 3, the UI page 300 includes different elements that are presented in different locations on the UI page 300. For example, the UI page 300 includes a logo of the merchant 312 (which can be an image or a text-based logo), a shopping cart image 322, and product images 314, 316, and 318 associated with different products offered for sale by the website. Some or all of the elements in the UI page 300 may be interactive. For example, the logo 312 may include a link that can direct the web browser to a homepage of the website. Each of the product images 314, 316, and 318 may also include a link that can direct the web browser to a product page associated with the corresponding product. The shopping cart image 322 may also include a link that can direct the web browser to a checkout page of the website. However, the link may be disabled when no items have been added to the shopping cart of the website, as indicated by the grayed-out image 322.

When the goal is to access a checkout page of the website, the AI model 208 may analyze the elements of the UI page 300, and may provide a set of navigation instructions that specify a selection of one of the product images 314, 316, and 318. By selecting one of the product images 314, 316, and 318, the web browser is directed to a product page associated with the corresponding product. For example, the selection of one of the product images 314, 316, and 318 may cause the web browser to transmit another HTTP request to the Internet based on an address associated with the link of the product page. The web browser may receive programming code associated with the product page in response to the HTTP request. The web browser may execute and/or interpret the programming code to render the product page on the display 250 of the computer system 200.

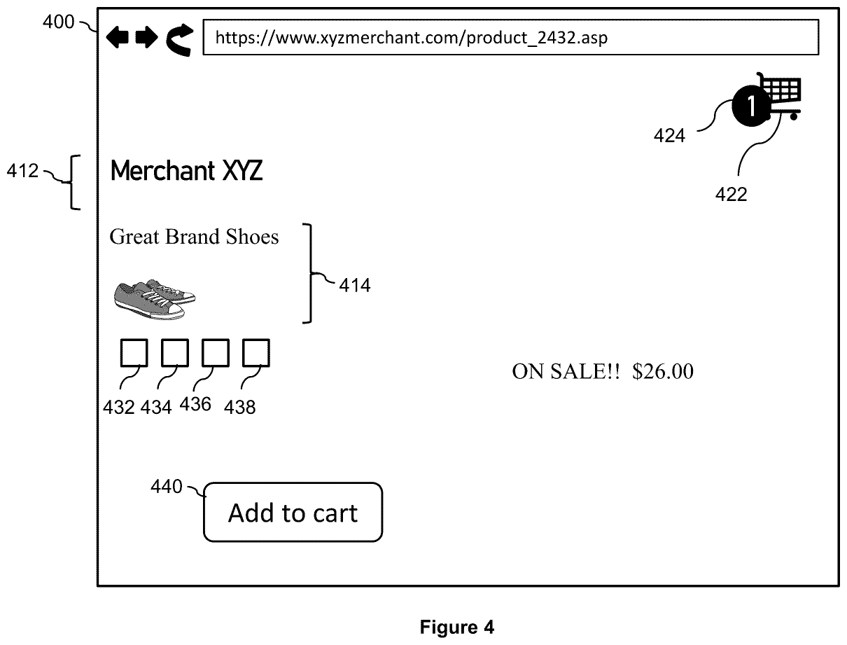

FIG. 4 illustrates an example rendering of a UI page 400 of an application according to some embodiments of the disclosure. In some embodiments, the UI page 400 corresponds to the product page associated with one of the products displayed on the UI page 300. As shown, the UI page 400 includes elements that are located at different locations of the UI page 400. For example, the UI page 400 includes a logo 412 of the merchant (which may include a link associated with a homepage of the website). The UI page 400 also includes a shopping cart image 422 (which may include a link associated with a checkout page of the website). The UI page 400 also includes descriptions 414 (including text and one or more images) of the product associated with the product page. In this example, the product is a pair of shoes and may be associated with different configurations (e.g., different colors, different sizes, etc.). As such, the UI page 400 includes selection boxes 432, 434, 436, and 438 associated with the different configurations of the product. The UI page 400 also includes an “add to cart button” 440 for adding a particular configuration of the product to the shopping cart. The “add to cart button” 400 may be disabled until a selection of one of the available configurations of the product has been made.

As discussed above, the shopping cart link may be disabled when no products have been added to the shopping cart. As such, after analyzing the UI page 400 using the techniques disclosed herein, the AI model 208 may generate a set of navigation instructions for navigating to the checkout page of the website. The set of navigation instructions may include an ordered sequence of interactions, including first a selection of one of the selection boxes 432, 434, 436, and 438 for selecting a particular configuration of the product. After selecting one of the selection boxes 432, 434, 436, and 438, the “add to cart” button 440 may be activated. As such, the ordered sequence of interactions may include a selection of the “add to cart” button 440. After adding the particular configuration of the product to the shopping cart, the “shopping cart” button 422 may be activated, as indicated by an indication 424 indicating that one item has been added to the shopping cart. The ordered sequence of interactions may also include a selection of the “shopping cart” button 422. The navigation module 204 may perform the ordered sequence of interactions via the operating system 230 of the computer system 200. The sequence of interactions may cause the web browser to transmit another HTTP request to the Internet. The web browser may receive programming code associated with a “checkout” page of the website in response to the HTTP request.

In some embodiments, instead of providing the sequence of navigation instructions together, the AI model 208 may provide the navigation instructions one at a time. For example, the AI model 208 may provide a first instruction for selecting one of the selectable boxes 432, 434, 436, and 438. After selecting one of the selectable boxes 432, 434, 436, and 438, the navigation module 204 may analyze the UI page 400 again (which may be modified based on the selection of one of the selectable boxes 432, 434, 436, and 438, such as a highlight of the selected box and an activation of the “add to cart” button 440). Upon analyzing the modified UI page 400, the AI model 208 may provide a subsequent navigation instruction for selecting the activated “add to cart” button 440. The selection of the “add to cart” button 440 may further modify the appearance of the UI page 400. For example, the icon 424 may appear on the “shopping cart” button 422, indicating that an item has been added to the shopping cart. Furthermore, the “shopping cart” button 422 may also be activated due to the item being added to the shopping cart. The AI model 208 may then provide a last navigation instruction for selecting the “shopping cart” button 422.

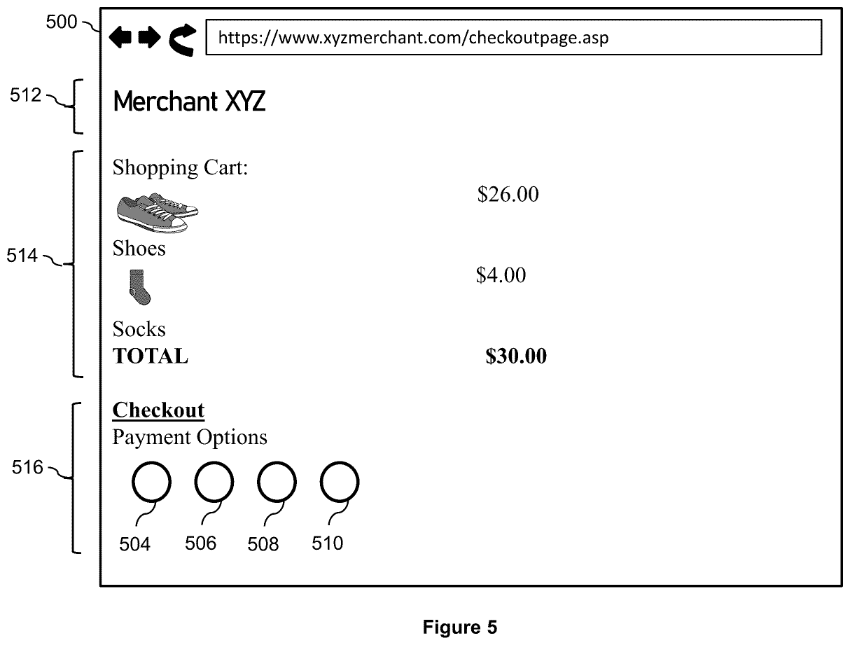

FIG. 5 illustrates an example rendering of a UI page 500 of an application according to some embodiments of the disclosure. In some embodiments, the UI page 500 corresponds to the “checkout” page of the website. As shown, the UI page 500 includes elements that are located at different locations of the UI page 500. For example, the UI page 500 includes a logo 512 of the merchant (which may include a link associated with a homepage of the website). The UI page 500 also includes description 514 of products that have been included in the shopping cart of the website. In this example, the UI page 500 indicates that the shopping cart includes a pair of shoes at a price of $26 and a pair of socks at a price of $4. The UI page 500 also includes a payment section 516 that presents different payment options represented by different UI elements 504, 506, 508, and 510. Each of the UI elements 504, 506, 508, and 510 may include text and/or an image representing a corresponding payment option (e.g., pay with PAYPAL™, pay with a VISA™ card, pay with an American Express™ card, pay with a Mastercard™ card, etc.).

In some embodiments, the navigation module 204 determines (or use the AI model 208 to determine) whether the UI page 500 corresponds to the target UI page (e.g., the “checkout” page) based on the existence of certain elements on the UI page 500 and the arrangement of those elements. For example, the navigation module 204 may determine that the UI page 500 corresponds to the target UI page if the UI page 500 includes elements that correspond to various payment options. If the navigation module 204 detects elements (e.g., the elements 504, 506, 508, and 510) within the UI page 500, the navigation module 204 may determine that the UI page 500 corresponds to the target UI page.

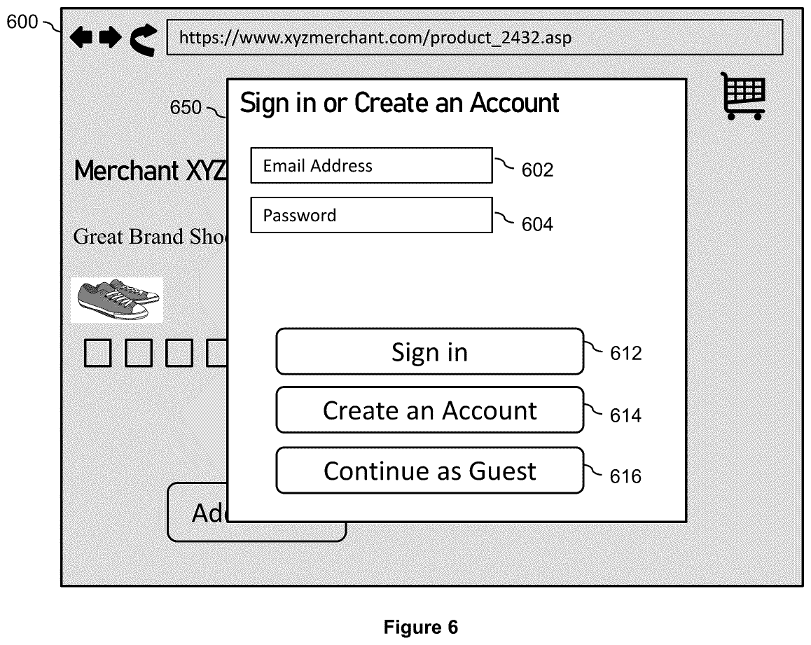

FIG. 6 illustrates an example rendering of a UI page 600 of an application according to some embodiments of the disclosure. In some embodiments, the UI page 600 corresponds to a UI page that has been modified in response to an interaction with an underlying UI page. For example, the website may require the operator to either sign in to an account with the website or proceed as a “guest user” when an item is added to the shopping cart of the website. As such, adding a product to a shopping cart of the website (e.g., by selecting the “add to cart” button 440 in the UI page 400, etc.) may cause the UI page 400 to be modified to the UI page 600. The modification may include a presentation of a pop-up window 650 that superimposes on top of the underlying UI page (e.g., the UI page 400). As shown, the pop-up window 650 includes multiple user interface elements, including text input fields 602 and 604 that enable an operator to provide login credentials (e.g., an email address, a password, etc.), a “sign in” button 612 for signing in to an account based on the credentials provided in the text input fields 602 and 604, a “create an account” button 614 for registering for a new account with the website, and a “continue as guest” button 616 for enabling the operator to conduct a transaction with the website as a guest user.

In this example, the AI model 208 may provide a navigation instruction for selecting the “continue as guest” button 616 to continue navigating through the website. However, if the pop-up window 650 does not provide an option to continue as a “guest user,” the AI model 208 may provide a set of navigation instructions for inserting credentials in the text input fields 602 and 604 if a fictitious account has been set up for the website. Otherwise, the AI model 208 may provide a set of navigation instructions for registering a new user account with the website. The set of navigation instructions may include selecting the “create an account” button 614 and instructions for providing information to the website in the subsequent user interface(s) for registering a new account.

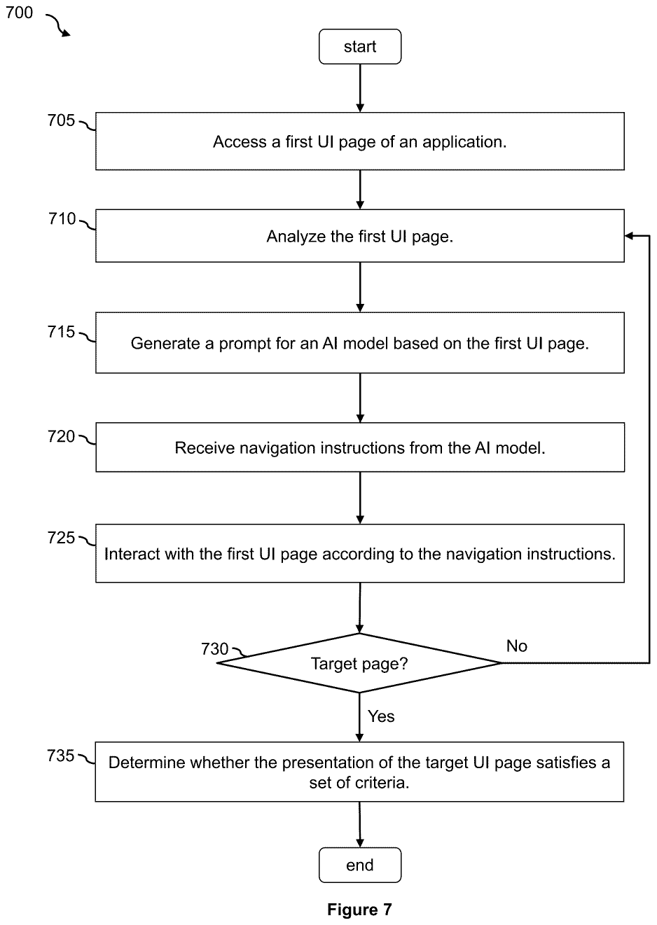

FIG. 7 illustrates a process 700 for navigating user interfaces under the AI model framework according to various embodiments of the disclosure. In some embodiments, at least a portion of the process 700 is performed by the UI analysis module 132, although one or more steps may be performed by one or more of the components/devices/modules/systems described herein. The process 700 begins by accessing (at step 705) a first UI page of an application. For example, the navigation module 204 may instruct the operating system 230 of the computer system 200 to launch a specific non-browser application (e.g., a merchant application, etc.). When the non-browser application is launched, the non-browser application may present, on the display 250, a home screen of the application. In another example, the navigation module 204 may instruct a web browser to access a website based on a network address of the website. The web browser may transmit a HTTP request based on the network address and may receive programming code associated with a homepage of the website. The web browser may then render the homepage of the website on the display 250.

After accessing the first UI page, the navigation module 204 analyzes (at step 710) the first UI page. For example, the navigation module 204 may obtain an image (e.g., a screenshot) corresponding to the first UI page via the operating system 230 of the computer system 200. The navigation module 204 may also analyze the different elements on the first UI page based on the programming code of the first UI page. In some embodiments, the navigation module 204 labels each element on the image of the first UI page based on the attributes of the element.

The navigation module 204 then generates (at step 715) a prompt for an AI model based on the first UI page. The prompt may include the image of the first UI page, the labeled elements on the image, the programming code associated with the first UI page, and specific instructions for navigating to a target UI page (e.g., a checkout page, an account summary page, etc.). The navigation module 204 provides the prompt to the AI model, and receives (at step 720) navigation instructions from the AI model based on the prompt. The navigation instructions may include instructions associated with one or more interactions with the first UI page. For example, the navigation instructions may specify a selection of a particular interactive UI element on the first UI page.

The navigation module 204 then interacts (at step 725) with the first UI page according to the navigation instructions. For example, the navigation module 204 may instruct the operating system 230 to provide one or more input signals (e.g., moving a cursor to a specific location on the display 250 and clicking at that location) to the first UI page. In response to the interaction, the application may be directed to a different UI page (e.g., a second UI page). The navigation module 204 determines (at step 730) if the second UI page corresponds to the target UI page.

If it is determined that the second UI page does not correspond to the target UI page, the navigation module 204 reverts back to the step 710, and repeats the steps 710 through 730. For example, the navigation module 204 may again use the AI model to analyze and interact with the second UI page to access another UI page of the application.

On the other hand, if it is determined that the second UI page corresponds to the target UI page, the navigation module 204 determines (at step 735) whether the presentation of the target UI page satisfies a set of criteria. For example, if the target UI page corresponds to a checkout page of the application, the navigation module 204 may determine whether the payment options presented on the target UI page is in a predetermined order.

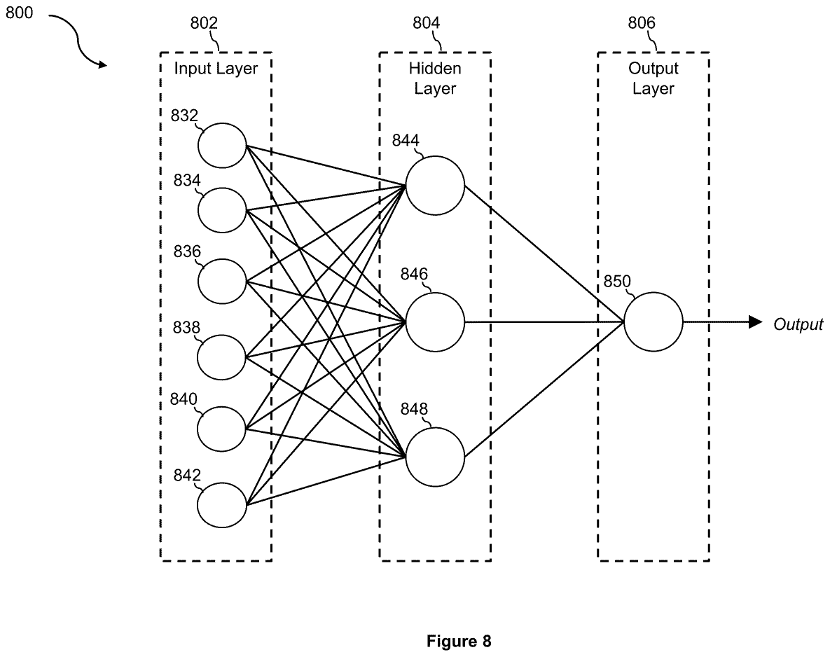

FIG. 8 illustrates an example artificial neural network 800 that may be used to implement a machine learning model, such as the AI model 208, the analytic module 218, and/or any one of the modules 212, 214, and 216. As shown, the artificial neural network 800 includes three layers—an input layer 802, a hidden layer 804, and an output layer 806. Each of the layers 802, 804, and 806 may include one or more nodes (also referred to as “neurons”). For example, the input layer 802 includes nodes 832, 834, 836, 838, 840, and 842, the hidden layer 804 includes nodes 844, 846, and 848, and the output layer 806 includes a node 850. In this example, each node in a layer is connected to every node in an adjacent layer via edges and an adjustable weight is often associated with each edge. For example, the node 832 in the input layer 802 is connected to all of the nodes 844, 846, and 848 in the hidden layer 804. Similarly, the node 844 in the hidden layer is connected to all of the nodes 832, 834, 836, 838, 840, and 842 in the input layer 802 and the node 850 in the output layer 806. While each node in each layer in this example is fully connected to the nodes in the adjacent layer(s) for illustrative purpose only, it has been contemplated that the nodes in different layers can be connected according to any other neural network topologies as needed for the purpose of performing a corresponding task.

The hidden layer 804 is an intermediate layer between the input layer 802 and the output layer 806 of the artificial neural network 800. Although only one hidden layer is shown for the artificial neural network 800 for illustrative purpose only, it has been contemplated that the artificial neural network 800 used to implement any one of the computer-based models may include as many hidden layers as necessary. The hidden layer 804 is configured to extract and transform the input data received from the input layer 802 through a series of weighted computations and activation functions.

In this example, the artificial neural network 800 receives a set of inputs and produces an output. Each node in the input layer 802 may correspond to a distinct input. For example, when the artificial neural network 800 is used to implement the AI model 208 or the analytic module 218, the nodes in the input layer 802 may correspond to representations of a prompt.

In some embodiments, each of the nodes 844, 846, and 848 in the hidden layer 804 generates a representation, which may include a mathematical computation (or algorithm) that produces a value based on the input values received from the nodes 832, 834, 836, 838, 840, and 842. The mathematical computation may include assigning different weights (e.g., node weights, edge weights, etc.) to each of the data values received from the nodes 832, 834, 836, 838, 840, and 842, performing a weighted sum of the inputs according to the weights assigned to each connection (e.g., each edge), and then applying an activation function associated with the respective node (or neuron) to the result. The nodes 844, 846, and 848 may include different algorithms (e.g., different activation functions) and/or different weights assigned to the data variables from the nodes 832, 834, 836, 838, 840, and 842 such that each of the nodes 844, 846, and 848 may produce a different value based on the same input values received from the nodes 832, 834, 836, 838, 840, and 842. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 802 is transformed into rather different values indicative data characteristics corresponding to a task that the artificial neural network 800 has been designed to perform.

In some embodiments, the weights that are initially assigned to the input values for each of the nodes 844, 846, and 848 may be randomly generated (e.g., using a computer randomizer). The values generated by the nodes 844, 846, and 848 may be used by the node 850 in the output layer 806 to produce an output value (e.g., a response to a user query, a prediction, etc.) for the artificial neural network 800. The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class. When the artificial neural network 800 is used to implement the AI model 208, the output node 850 (or multiple output nodes) may be configured to generate representations of a set of navigation instructions. When the artificial neural network 800 is used to implement the analytic module 218, the output node 850 (or multiple output nodes) may be configured to generate a classification indicating whether the target UI page satisfies a predetermined set of criteria.

In some embodiments, the artificial neural network 800 may be implemented on one or more hardware processors, such as CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware used to implement the neural network structure is specifically configured based on factors such as the complexity of the neural network, the scale of the tasks (e.g., training time, input data scale, size of training dataset, etc.), and the desired performance.

The artificial neural network 800 may be trained by using training data based on one or more loss functions and one or more hyperparameters. By using the training data to iteratively train the artificial neural network 800 through a feedback mechanism (e.g., comparing an output from the artificial neural network 800 against an expected output, which is also known as the “ground-truth” or “label”), the parameters (e.g., the weights, bias parameters, coefficients in the activation functions, etc.) of the artificial neural network 800 may be adjusted to achieve an objective according to the one or more loss functions and based on the one or more hyperparameters such that an optimal output is produced in the output layer 806 to minimize the loss in the loss functions. Given the loss, the negative gradient of the loss function is computed with respect to each weight of each layer individually. Such negative gradient is computed one layer at a time, iteratively backward from the last layer (e.g., the output layer 806 to the input layer 802 of the artificial neural network 800). These gradients quantify the sensitivity of the network's output to changes in the parameters. The chain rule of calculus is applied to efficiently calculate these gradients by propagating the gradients backward from the output layer 806 to the input layer 802.

Parameters of the artificial neural network 800 are updated backwardly from the last layer to the input layer (backpropagating) based on the computed negative gradient using an optimization algorithm to minimize the loss. The backpropagation from the last layer (e.g., the output layer 806) to the input layer 802 may be conducted for a number of training samples in a number of iterative training epochs. In this way, parameters of the artificial neural network 800 may be gradually updated in a direction to result in a lesser or minimized loss, indicating the artificial neural network 800 has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as to predict a frequency of future related transactions.

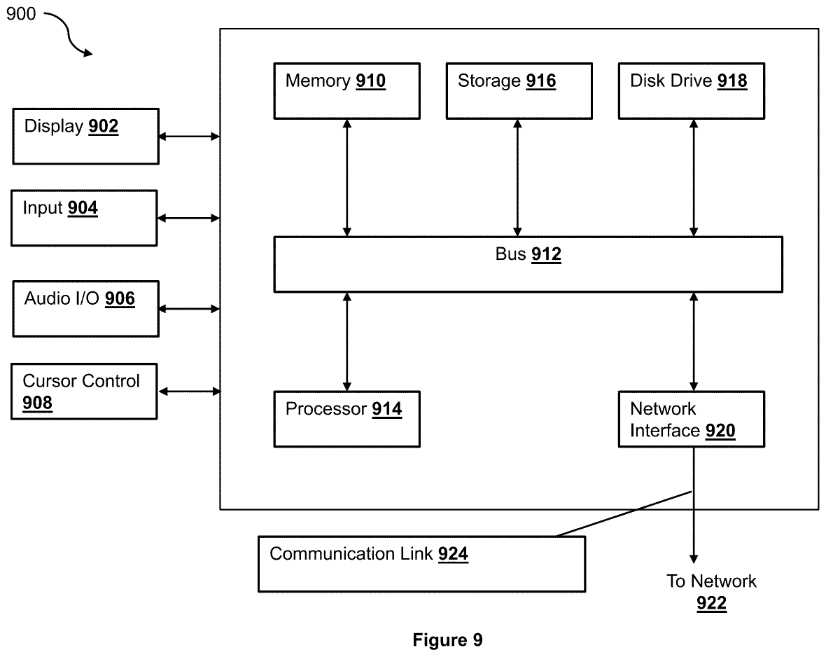

FIG. 9 is a block diagram of a computer system 900 suitable for implementing one or more embodiments of the present disclosure, including the service provider server 130, the merchant server 120, the user device 180, and the user device 110. In various implementations, each of the user devices 110 and 180 may include a mobile cellular phone, personal computer (PC), laptop, wearable computing device, etc. adapted for wireless communication, and each of the service provider server 130 and the merchant server 120 may include a network computing device, such as a server. Thus, it should be appreciated that the devices 110, 120, 130, and 180 may be implemented as the computer system 900 in a manner as follows.

The computer system 900 includes a bus 912 or other communication mechanism for communicating information data, signals, and information between various components of the computer system 900. The components include an input/output (I/O) component 904 that processes a user (i.e., sender, recipient, service provider) action, such as selecting keys from a keypad/keyboard, selecting one or more buttons or links, etc., and sends a corresponding signal to the bus 912. The I/O component 904 may also include an output component, such as a display 902 and a cursor control 908 (such as a keyboard, keypad, mouse, etc.). The display 902 may be configured to present a login page for logging into a user account or a checkout page for purchasing an item from a merchant. An optional audio input/output component 906 may also be included to allow a user to use voice for inputting information by converting audio signals. The audio I/O component 906 may allow the user to hear audio. A transceiver or network interface 920 transmits and receives signals between the computer system 900 and other devices, such as another user device, a merchant server, or a service provider server via a network 922. In one embodiment, the transmission is wireless, although other transmission mediums and methods may also be suitable. A processor 914, which can be a micro-controller, digital signal processor (DSP), or other processing component, processes these various signals, such as for display on the computer system 900 or transmission to other devices via a communication link 924. The processor 914 may also control transmission of information, such as cookies or IP addresses, to other devices.

The components of the computer system 900 also include a system memory component 910 (e.g., RAM), a static storage component 916 (e.g., ROM), and/or a disk drive 918 (e.g., a solid-state drive, a hard drive). The computer system 900 performs specific operations by the processor 914 and other components by executing one or more sequences of instructions contained in the system memory component 910. For example, the processor 914 can perform the automated UI page navigation functionalities described herein, for example, according to the process 700.

Logic may be encoded in a computer readable medium, which may refer to any medium that participates in providing instructions to the processor 914 for execution. Such a medium may take many forms, including but not limited to, non-volatile media, volatile media, and transmission media. In various implementations, non-volatile media includes optical or magnetic disks, volatile media includes dynamic memory, such as the system memory component 910, and transmission media includes coaxial cables, copper wire, and fiber optics, including wires that comprise the bus 912. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 900. In various other embodiments of the present disclosure, a plurality of computer systems 900 coupled by the communication link 924 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system comprising:
a non-transitory memory; and
one or more hardware processors coupled with the non-transitory memory and configured to execute instructions from the non-transitory memory to cause the system to:
obtain an image of a first webpage of a website corresponding to a webpage identifier;
analyze the first webpage, wherein analyzing the first webpage comprises labeling user interface elements within the image of the first webpage based on programming code associated with the first webpage;
generate a prompt for instructing an artificial intelligence (AI) model to provide a set of navigation instructions for navigating to a target webpage within the website based on the image of the first webpage and the labeled user interface elements;
obtain the set of navigation instructions from the AI model; and
interact with the first webpage according to the set of navigation instructions, wherein interacting with the first webpage according to the set of navigation instructions enables the system to access a second webpage of the website.

2. The system of claim 1, wherein executing the instructions further causes the system to:
analyze the second webpage; and
determine whether the second webpage corresponds to the target webpage based on analyzing the second webpage.

3. The system of claim 2, wherein executing the instructions further causes the system to:
in response to determining that the second webpage corresponds to the target webpage, determine that the second webpage satisfies a set of criteria associated with the target webpage.

4. The system of claim 2, wherein executing the instructions further causes the system to:
in response to determining that the second webpage does not correspond to the target webpage, label second user interface elements within a second image of the second webpage;
generate a second prompt for instructing the AI model to provide a second set of navigation instructions for navigating to the target webpage based on the second image of the second webpage and the labeled second user interface elements;
obtain the second set of navigation instructions from the AI model; and
interact with the second webpage according to the second set of navigation instructions.

5. The system of claim 2, wherein the computer module is a second AI model.

6. The system of claim 1, wherein the set of navigation instructions comprises an instruction for selecting a particular user interface elements from the user interface elements within the first webpage.

7. The system of claim 6, wherein the instruction for selecting the particular user interface elements comprises a set of coordinates associated with the particular user interface element within the image.

8. A method comprising:
generating, by a computer system, a rendering of a first user interface (UI) page of an application associated with an entity;
analyzing, by the computer system, the first UI page, wherein the analyzing the first UI page comprises labeling UI elements within the first UI page;
generating, by the computer system, a prompt for instructing an artificial intelligence (AI) model to provide a set of navigation instructions for navigating to a target UI page within the application based on the rendering of the first UI page and the labeled UI elements;
obtaining, by the computer system, the set of navigation instructions from the AI model; and
interacting, by the computer system and via an operating system of the computer system, with the rendering of the first UI page according to the set of navigation instructions, wherein the interacting with the rendering of the first UI page enables the computer system to access a second UI page of the application.

9. The method of claim 8, wherein the first UI page comprises a pop-up window, and wherein the set of navigation instructions comprises an instruction for closing the pop-up window.

10. The method of claim 8, wherein the UI elements within the first UI page comprise one or more text input fields, and wherein the set of navigation instructions comprises providing data in the text input fields and submitting the data via the first UI page.

11. The method of claim 8, further comprising:
determining that the first UI page comprises a puzzle based on the analyzing the first UI page,
wherein the prompt comprises an instruction to solve the puzzle, and
wherein the set of navigation instructions comprises a set of instructions for solving the puzzle.

12. The method of claim 8, further comprising:
analyzing the second UI page; and
determining whether the second UI page corresponds to the target UI page based on the analyzing the second UI page.

13. The method of claim 12, further comprising:
in response to determining that the second UI page corresponds to the target UI page, determining that the second UI page satisfies a set of criteria associated with the target UI page.

14. The method of claim 12, further comprising:
in response to determining that the second UI page does not correspond to the target UI page, obtaining a second set of navigation instructions from the AI model based on the second UI page; and
interacting with the second UI page according to the second set of navigation instructions.

15. A non-transitory machine-readable medium having stored thereon machine-readable instructions executable to cause a machine to perform operations comprising:
obtaining an image of a first user interface (UI) page of an application that is rendered by a UI application of the machine;
analyzing the first UI page, wherein analyzing the first UI page comprises labeling UI elements within the image of the first UI page based on programming code associated with the first UI page;
generating a prompt for instructing an artificial intelligence (AI) model to provide a set of navigation instructions for navigating to a target UI page within the application based on the image of the first UI page and the labeled user interface elements;
obtaining the set of navigation instructions from the AI model; and
interacting with the first UI page according to the set of navigation instructions, wherein the interacting with the first UI page according to the set of navigation instructions causes the UI application to access a second UI page of the application.

16. The non-transitory machine-readable medium of claim 15, wherein the operations further comprise:
analyzing the second UI page; and
determining whether the second UI page corresponds to the target UI page based on the analyzing the second UI page.

17. The non-transitory machine-readable medium of claim 16, wherein operations further comprise:
in response to determining that the second UI page corresponds to the target UI page, determine that the second UI page satisfies a set of criteria associated with the target UI page.

18. The non-transitory machine-readable medium of claim 16, wherein the operations further comprise:
in response to determining that the second UI page does not correspond to the target UI page, obtaining a second set of navigation instructions from the AI model based on the second UI page; and
interacting with the second UI page according to the second set of navigation instructions.

19. The non-transitory machine-readable medium of claim 15, wherein the set of navigation instructions comprises an instruction for selecting a particular user interface elements from the user interface elements within the first UI page.

20. The non-transitory machine-readable medium of claim 19, wherein the instruction for selecting the particular user interface elements comprises a set of coordinates associated with the particular user interface element within the image.
